(19) United States
(12) Patent Application Publication
(10) Pub. No.: US 2014/0186626 A1
(43) Pub. Date: Jul. 3, 2014

(54) MODIFIED STARCH, PREPARATION METHOD AND USE OF THE SAME, AND DRILLING FLUID

(71) Applicants: SINOPEC RESEARCH INSTITUTE OF PETROLEUM ENGINEERING, Beijing (CN); CHINA PETROLEUM & CHEMICAL CORPORATION, Beijing (CN)

(72) Inventors: Zhifa WANG, Beijing (CN); Zhi Yang, Beijing (CN); Yongxue Lin, Beijing (CN); Xiaohua Yang, Beijing (CN); Jiang Xu, Beijing (CN); Long Chai, Beijing (CN); Zhoujun Li, Beijing (CN); Guo Zhang, Beijing (CN); Yang Xu, Beijing (CN); Haibo Wang, Beijing (CN); Yong Kong, Beijing (CN)

(73) Assignees: SINOPEC RESEARCH INSTITUTE OF PETROLEUM ENGINEERING, Beijing (CN); CHINA PETROLEUM & CHEMICAL CORPORATION, Beijing (CN)

(21) Appl. No.: 14/031,366

(22) Filed: Sep. 19, 2013

(30) Foreign Application Priority Data
Sep. 19, 2012 (CN) 201210350945.7
Sep. 19, 2012 (CN) 201210351015.3

(51) Int. Cl. C09K 8/035

(52) U.S. Cl. CPC C09K 8/035
USPC 428/402; 536/111

(57) ABSTRACT

The present invention provides a modified starch, preparation method and use of the same, also provides a drilling fluid comprising the modified starch which contains bi-substituted starch structural units and tri-substituted starch structural units, wherein, the tri-substituted starch structural units are represented by the following formula (1), the bi-substituted starch structural units are the structural units represented by the following formula (2) and/or the structural units represented by the following formula (3), and the total content of the bi-substituted starch structural units and tri-substituted starch structural units accounts for 20 wt % or more of the modified starch, preferably 20-30 wt %, the weight-average molecular weight of the etherified starch is 50,000-600,000, preferably 80,000-580,000, wherein, R₁, R₂, and R₃ are C1-C5 alkylene respectively, and M₁, M₂, and M₃ are H, alkali metal element, or alkaline earth metal element respectively.

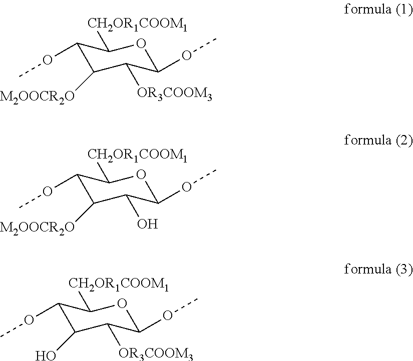

### CROSS REFERENCE TO RELATED APPLICATIONS

This application claims the priority to Chinese Application No. 201210350945.7, filed on Sep. 19, 2012, entitled “Preparation method of a high temperature resistance modified starch for drilling fluid”; and claims the priority to Chinese Application No. 201210351015.3, filed on Sep. 19, 2012, entitled “A high temperature resistance modified starch for drilling fluid”, which are specifically and entirely incorporated by reference.

### FIELD OF THE INVENTION

The present invention relates to a modified starch, a preparation and use of the same, and a drilling fluid comprising modified starch.

### BACKGROUND OF THE INVENTION

Modified starch is often used as a filtrate reducer in petroleum drilling engineering, mainly because modified starch has favorable filtrate reduction effect and reservoir bed protection, biodegradable, and biotoxicity-free characteristics. There are mainly three methods for chemical modification of starch into a high-temperature resistant filtrate reducer for drilling fluid: gelatinization, etherification, and graft copolymerization. Wherein, gelatinization has major advantages of simple production process and low cost, but has a disadvantage of poor thermostability, and usually can only be used at 80-100° C. borehole temperature; products synthesized through etherification can be used alone at 100-130° C. temperature, and have characteristics such as low molecular weight (approx. 50,000) and a large number of ether bonds in molecule; owing to the fact that the bond breaking temperature of ether bonds is approx. 140° C., it is difficult to use the etherification method to synthesize a product that can be used at 130-140° C. temperature; for products that are commonly used as high-temperature resistant filtrate reducers for drilling fluid, such as sodium carboxymethyl starch (CMS-Na), hydroxypropyl starch (HPS), and cationic starch (CS), etc., a great deal of deoxidant and bactericide have to be added into the drilling fluid to improve high-temperature resistance and salt resistance of such products, if the service temperature is higher than 130° C.; products synthesized through graft copolymerization can be used at 130-180° C. temperature, and such products have an advantage that the product obtained through graft copolymerization has high molecular weight and is helpful for improving thermostability of starch, but have disadvantages such as complex production process, and low degradability and high cost of the synthesized product.

In the prior art, high-temperature resistant modified starch products for drilling fluid are usually prepared through a dry process; for example, a temperature-resistant starch compound for drilling fluid and a method for preparation of the starch compound are provided in Chinese patent document CN101255333A, wherein, the temperature-resistant starch compound is obtained by adding a quaternary ammonium salt-based cationic surfactant and a cross-linking agent. The product prepared through a dry process is usually in block form, and has to be crushed before it can be used in the actual application; moreover, the temperature-resistant starch compound obtained with that method has to be further improved in terms of the temperature-resistant performance.

In addition, viewed generally, there is no temperature-resistant starch product that can be used at temperature above 130° C. in the market yet up to now.

### SUMMARY OF THE INVENTION

To overcome the drawback that the etherified starch can be only used at 100-130° C. temperature in the prior art, the present invention provides an etherified starch that can be used at temperature above 130° C., a method for preparation and use of the etherified starch, and a drilling fluid that contains the etherified starch.

In a first aspect of the present invention, the present invention provides a modified starch, which contains bi-substituted starch structural units and tri-substituted starch structural units, wherein, the tri-substituted starch structural units are represented by the following formula (1), the bi-substituted starch structural units are the structural units represented by the following formula (2) and/or the structural units represented by the following formula (3), and the total content of the bi-substituted starch structural units and tri-substituted starch structural units accounts for 20 wt % or more of the modified starch, the weight-average molecular weight of the modified starch is 50,000-600,000,

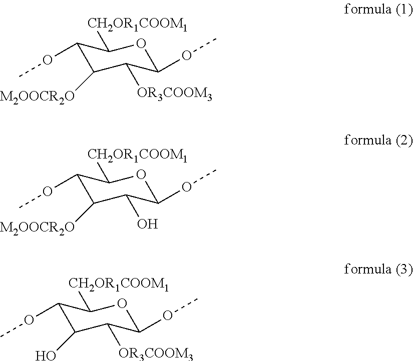

where, R₁, R₂, and R₃ are C1-C5 alkylene respectively, and M₁, M₂, and M₃ are H, alkali metal element, or alkaline earth metal element respectively.

In a second aspect of the present invention, the present invention provides a modified starch, which exhibits an anti-symmetric stretching vibration absorption peak of —CH₂ at or near wave number 2930.80 cm⁻¹, exhibits stretching vibration absorption peaks of ether bond C—O—C at or near wave numbers 1158.87 cm⁻¹, 1081.21 cm⁻¹, and 1048.84 cm⁻¹, and exhibits anti-symmetric and symmetric stretching vibration absorption peaks of ion —COO— at or near wave numbers 1609.69 cm⁻¹ and 1426.37 cm⁻¹ on the infrared spectrogram.

In a third aspect of the present invention, the present invention provides a method for preparation of modified starch, comprising: controlling a mixture that contains raw starch, starch acylating agent, and solvent to contact with a basic catalyst, wherein, the contact between the mixture contains raw starch, starch acylating agent, and solvent and the basic catalyst comprises at least two stages, the contact time in the first stage is 1-48 h, and the amount of basic catalyst used in the first stage accounts for ⅛-⅜ of the total amount of the basic catalyst.

In a fourth aspect of the present invention, the present invention provides a method for preparation of high-temperature resistant modified starch for drilling fluid, comprising: dissolving raw starch in low carbon alcohol to obtain a 15-25 wt % starch suspension liquid; adding 1-2 part by weight (pbw) 3-10 wt % chloroacetic acid solution into 3-4 pbw starch suspension first, and then adding 2-3 pbw 4-11 wt % catalyst solution into the starch suspension in twice, wherein, the weight of catalyst solution added in the first cycle accounts for ⅛-⅜ of the total weight of the catalyst solution, the mixture is kept at 40-70° C. to react for 1-48 h after the catalyst solution is added for the first stage, and then the remaining catalyst solution is added and the mixture is kept at 40-70° C. to react further for 0.5-24 h; neutralizing the solution with acid to pH=7.5-9 after the reaction; washing the product of the reaction with low carbon alcohol and then drying the product of the reaction to obtain the final product.

In a fifth aspect of the present invention, the present invention provides a modified starch prepared with the method described above.

In a sixth aspect of the present invention, the present invention provides a use of the above-mentioned modified starch in drilling fluids.

In a seventh aspect of the present invention, the present invention provides a drilling fluid that contains the above-mentioned modified starch.

The modified starch provided in the present invention can be used in a temperature higher than 130° C., wherein, the filter loss of the modified starch is less than 10 ml when it is used in industrial applications without any deoxidant and bactericide, as evaluated by 16 h aging test at 140° C. as per the API standard for modified starch, i.e., Spec 13A ISO 13500 2009. In contrast, under the same testing conditions, the filter loss of unmodified raw starch is 102 ml or more, and the filter loss of modified starch prepared with the method disclosed in Chinese patent document CN101255333A is 72 ml or more. Therefore, the modified starch provided in the present invention is especially suitable for use as a filtrate reducer for drilling fluid.

### BRIEF DESCRIPTION OF THE DRAWINGS

FIG. 1 shows SEM images, wherein, (a) is a SEM image of the modified starch prepared in Example 1 of the present invention, (b) is a SEM image of a commercial etherified starch (the modified starch used in Comparison Test Example 3), and (c) is a SEM image of unmodified raw starch.

FIG. 2 shows infrared spectrograms, wherein, (a) is an infrared spectrogram of the modified starch prepared in Example 1 of the present invention, and (b) is an infrared spectrogram of raw starch.

FIG. 3 shows a thermogravimetric curve of the modified starch prepared in Example 1 of the present invention.

FIG. 4 shows photos of starch, wherein, (a) is a photo of a modified starch product prepared with the method in Example 1 of the present invention, and (b) is a photo of the modified starch product used in Comparison Test Example 3.

FIG. 5 shows SEM images of mud cakes, wherein, (a) is a SEM image of the mud cake obtained in Test Example 1, and (b) is a SEM image of the mud cake obtained in Comparison Test Example 3.

### DETAILED DESCRIPTION OF THE EMBODIMENTS

In a first aspect of the present invention, the present invention provides a modified starch, which contains bi-substituted starch structural units and tri-substituted starch structural units, wherein, the tri-substituted starch structural units are represented by the following formula (1), the bi-substituted starch structural units are the structural units represented by the following formula (2) and/or the structural units represented by the following formula (3), and the total content of the bi-substituted starch structural units and tri-substituted starch structural units accounts for 20 wt % or more of the modified starch, preferably 20-30 wt %, the weight-average molecular weight of the etherified starch is 50,000-600,000, preferably 80,000-580,000,

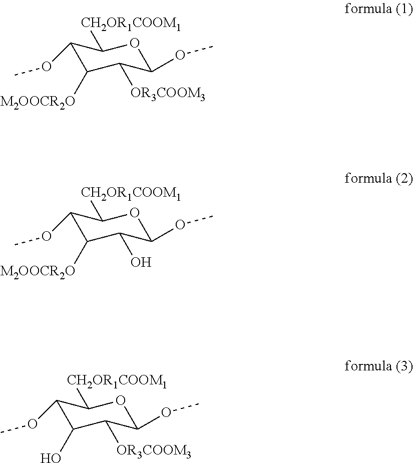

where, R₁, R₂, and R₃ are C1-C5 alkylene respectively, and M₁, M₂, and M₃ are H, alkali metal element, or alkaline earth metal element respectively.

For the modified starch, obviously the remains are mono-substituted (usually substituted on sixth C) starch structural units and unsubstituted starch structural units.

In the present invention, the alkylene refers to the remaining part of alkane after the alkane loses two hydrogen atoms. The two lost hydrogen atoms can be in the same carbon atom originally or in different carbon atoms originally. The C1-C5 alkylene can be methylene, ethylidene, propylidene, or butylidene, for example.

The alkali metal element can be Li, Na, or K, for example.

The alkaline earth metal element can be Mg, Ca, or Ba, for example.

Preferably, in the present invention, R₁, R₂, and R₃ are methylene respectively, and M₁, M₂, and M₃ are H or Na respectively.

More preferably, in the present invention, the degree of substitution of the modified starch is 0.2-0.5, preferably 0.3-0.5. It is known on the basis of the structural formula of starch: the degree of substitution of modified starch can be 1 at the most. A glucose unit has 3 hydroxyl hydrogen atoms, which can be substituted by ether bonds at the same time theoretically. However, since etherification modified groups are ionized groups, only the hydroxyl on the sixth C in the original starch structure is substituted with the ordinary etherification modification method; after the hydrogen atom of the hydroxyl on the sixth C is substituted, strong steric hindrance effect is created, and consequently it is difficult to have substitution reaction on other hydrogen atoms; as a result, the degree of substitution of existing modified starch products is usually lower than 0.2. The degree of substitution is a major indicator that has influence on the application scope of the high temperature-resistant modified starch. Usually, the degree of substitution of modified starch is tested by complexometric titration.

The principle of measuring the degree of substitution of modified starch by complexometric titration is: the carboxyl groups on carboxymethyl starch can have precipitation reaction with copper ion proportionally. By adding standard copper solution in a known over amount into the sample, filtering the precipitate after the precipitation reaction is completed, and titrating the excessive copper with standard EDTA solution at pH=7.5˜8, the degree of substitution of carboxymethyl can be deduced.

2StOCH₂COONa+CuSO4→(StOCH₂COO)₂Cu⇓+Na₂SO₄Cu²⁺+EDTA→Cu−EDTA

Specifically, the testing method is as follows:

a) Instruments: volumetric flask (250 ml), pipette (100 ml), burette (50 ml), and mutche filter.
b) Reagents: 0.01 mol/L CuSO₄ solution, 0.05 mol/L standard EDTA solution, NH₄Cl buffer solution (pH=5.2, 10 g NH₄Cl is dissolved in 1 L water), murexide indicator (0.1 g murexide and 10 g NaCl are grinded together to homogeneous state)
c) Operation steps

Weigh approx. 0.5 g modified starch sample accurately and load it into a 100 ml beaker, add 1 ml ethanol to wet the sample, then add 50 ml water, 20 ml NH₄Cl buffer solution, and adjust the pH of the solution to 7.5˜8.0 with 0.1 mol/L HCl or 0.1 mol/L NaOH. Transfer the solution into a 250 ml volumetric flask, add 50 ml CuSO₄ solution, shake up, and place for 15 min. Dilute to the scale mark, shake up, filter, take 100 ml filtrate, and use murexide as an indicator and titrate with standard EDTA solution to the end point. Measure blank copper sulphate solution under the same conditions.

d) Calculate the degree of substitution DS with the following formula:

$${W}_{B} = \frac{{C}_{EDTA} \times ( {V}_{Blank} - {V}_{Sample} ) \times 0.162 \times \frac{250}{100}}{m ( Drybasis )} \times 100$$

$$DS = \frac{162 {w}_{B}}{8100 - 80 {w}_{B}}$$

where, m (drybasis)—dry weight of the sample (g)
W_{B}—Content of sodium acetate radicals
C_{EDTA}—Concentration of standard EDTA solution, mol/L
V_{Blank}—EDTA volume consumed by blank sample, mL
V_{Sample}—EDTA volume consumed by sample, mL

In the present invention, the degree of substitution of modified starch is measured with the complexometric titration method described above.

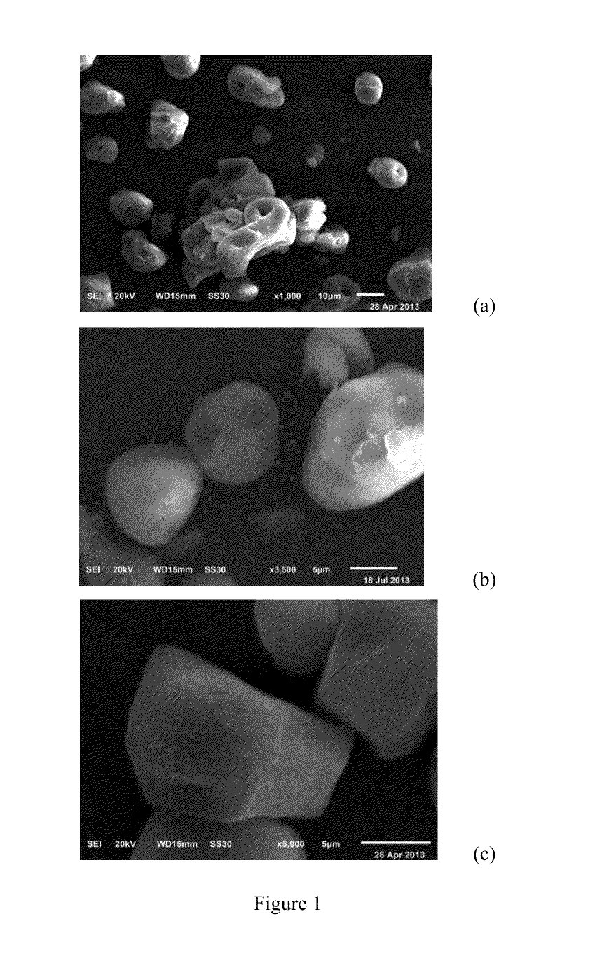

Preferably, as shown in FIG. 1, the particles of the modified starch described in the present invention are in doughnut shape. More preferably, the average ratio of inner diameter/outer diameter of doughnut is 1:10-15, the average thickness of doughnut is 0.1-2 μm, and the average particle diameter of doughnut is 3-20 μm. The doughnut-shaped modified starch particles can exist separately, or 1-2 doughnuts can be connected into ∝ shape or ∞ shape, as shown in FIG. 1(a).

In the present invention, the doughnut-shaped appearance of the modified starch and relevant dimensional data are ascertained by SEM.

For the sake of comparison, (b) and (c) of FIG. 1 show a SEM image of commercial etherified starch and a SEM image of unmodified raw starch respectively.

It is seen from the comparison among (a), (b), and (c) of FIG. 1: the morphology of the modified starch provided in the present invention is obviously different from the morphology of unmodified raw starch and the morphology of commercial etherified starch.

More preferably, the density of the modified starch is 1.2-1.8 g/cm³.

Furthermore, the inventor finds: the filter loss of the modified starch provided in the present invention is always less than 10 ml when it is used in industrial applications without any deoxidant and bactericide, as evaluated by 16 h aging test at 130° C., 135° C., and 140° C. respectively as per the API standard for modified starch, i.e., Spec 13A ISO 13500 2009. In contrast, under the same testing conditions, the filter loss of unmodified raw starch is 100 ml or more, and the filter loss of modified starch prepared with the method disclosed in Chinese patent document CN101255333A is 72 ml or more. Thus it can be seen that the modified starch provided in the present invention has significantly improved high-temperature resistance performance, and can be absolutely used at 140° C.

In a second aspect of the present invention, the present invention provides a sort of modified starch, which exhibits an anti-symmetric stretching vibration absorption peak of —CH₂ at or near wave number 2930.80 cm⁻¹, exhibits stretching vibration absorption peaks of ether bond C—O—C at or near wave numbers 1158.87 cm⁻¹, 1081.21 cm⁻¹, and 1048.84 cm⁻¹, and exhibits anti-symmetric and symmetric stretching vibration absorption peaks of ion —COO— at or near wave numbers 1609.69 cm⁻¹ and 1426.37 cm⁻¹ on the infrared spectrogram. Wherein, the peak height ratio of anti-symmetric stretching vibration absorption peak of ion —COO— that appears at or near wave number 1609.69 cm⁻¹: symmetric stretching vibration absorption peak of ion —COO— that appears at or near wave number 1426.37 cm⁻¹: stretching vibration absorption peak of ether bond C—O—C that appears at or near wave number 1158.87 cm⁻¹ is 1-2:1-2:1, and the peak area ratio of the three peaks is 10-13:3-6:1.

In a third aspect of the present invention, the present invention provides a method for preparation of modified starch, comprising: controlling a mixture that contains raw starch, starch acylating agent, and solvent to contact with a basic catalyst, wherein, the contact between the mixture contains raw starch, starch acylating agent, and solvent and the basic catalyst at least comprises two stages, the contact time in the first stage is 1-48 h, and the amount of basic catalyst used in the first stage accounts for 1/16-½ of the total amount of the basic catalyst.

According to the method for preparation of modified starch provided in the present invention, though the modified starch that has high-temperature resistance and salt resistance properties can be obtained simply by adding a basic catalyst in twice or more times at a time interval within 1-48 h range and controlling the amount of basic catalyst added in the first time to 1/16-½ of the total weight of the basic catalyst, preferably the contact time in the first stage is 3-6 h, and the amount of basic catalyst used in the first stage accounts for ⅛-⅜ of the total weight of the basic catalyst. More preferably, the contact process is performed in two stages, and the contact time in the second stage is 0.5-24 h, preferably 2-4-h. The contact temperatures in each stage may be the same as or different from each other, and are 40-70° C. respectively.

According to a preferred embodiment of the present invention, the weight ratio of raw starch:starch acylating agent:solvent:basic catalyst is 1:0.06-0.2:4-7:0.17-0.33.

In the present invention, the raw starch can be any starch that is not treated by etherification or grafting, etc., and preferably is composed of one or more of maize starch, potato starch, and cassava starch.

The starch acylating agent can be any agent that can acylate or etherify the hydroxyl groups in starch. In the present invention, the starch acylating agent is preferably C2-C4 halogenated carboxylic acid, such as one or more of chloroacetic acid, bromoacetic acid, dichloroacetic acid, dibromoacetic acid, trichloroacetic acid, and tribromoacetic acid.

The solvent can be any organic or inorganic solvent that can dissolve or disperse raw starch and basic catalyst, such as water and/or C1-C4 low carbon alcohol. Preferably, the low carbon alcohol is composed of one or more of methanol, ethanol, and isopropanol.

The basic catalyst can be any alkaline matter that can catalyze etherification reaction of starch, and preferably is sodium hydroxide and/or potassium hydroxide.

According to an embodiment of the present invention, the mixture that contains raw starch, starch acylating agent, and water containing solvent is prepared by mixing raw starch with water to form a suspension and then mixing the suspension with water solution of the starch acylating agent and/or C1-C4 low carbon alcohol solution of the starch acylating agent. More preferably, the concentration of the suspension is 15-25 wt %, and the concentration of the water solution of starch acylating agent is 3-10 wt %.

Preferably, the catalyzed reaction process proceeds with agitation after the catalyst is added, and the agitation speed is 500-1000 rpm.

Preferably, the method provided in the present invention further comprises: neutralizing the pH of the mixture obtained through contact reaction to 7.5-9 with acid, and then washing the mixture with C1-C4 low carbon alcohol and drying the mixture.

The acid can be one or more of hydrochloric acid, sulfuric acid, and acetic acid. The drying temperature can be 50-60° C.

According to a preferred embodiment of the present invention, the method for preparation of modified starch provided in the present invention comprises: dissolving raw starch in low carbon alcohol to obtain a 15-25 wt % starch suspension liquid; adding 1-2 part by weight (pbw) 3-10 wt % chloroacetic acid solution into 3-4 pbw starch suspension first, and then adding 2-3 pbw 4-11 wt % catalyst solution into the starch suspension in twice, wherein, the weight of the catalyst solution added in the first time accounts for ⅛˜⅜ of the total weight of the catalyst solution, the mixture is kept at 40-70° C. to react for 1-48 h after the catalyst solution is added for the first time, and then the remaining catalyst solution is added and the mixture is kept at 40-70° C. to react further for 0.5-24 h; neutralizing the solution with acid to pH=7.5-9 after the reaction; washing the product of the reaction with low carbon alcohol and then drying the product of the reaction to obtain the final product.

In a fifth aspect of the present invention, the present invention provides a modified starch prepared with the method described above. The particles of the modified starch prepared with the method described above are in doughnut shape. More preferably, the average ratio of inner diameter/outer diameter of doughnut is 1:10-15, the average thickness of doughnut is 0.1-2 μm, and the average particle diameter of doughnut is 3-20 μm. The degree of substitution is 0.2-0.5. The density can be up to 1.2-1.8 g/cm³. In addition, the filter loss of the modified starch described above is always less than 10 ml when it is used in industrial applications without any deoxidant and bactericide, as evaluated by 16 h aging test at 130° C., 135° C., and 140° C. respectively as per the API standard for modified starch, i.e., Spec 13A ISO 13500 2009.

In the present invention, the modified starch is white powder, and is prepared through a wet process. Therefore, it can be seen from the particle size distribution diagram: the particles with particle diameter within 100-250 μm range account for 80% or greater volume of the starch.

It can be seen from application and characterization, the product prepared with the method described in the present invention are superior to existing products in terms of functional features; in addition, the method is simple, and any anti-swelling agent (e.g., sodium chloride or sodium sulfate, etc.) is not required in the preparation method. Therefore, the production process is more environmentally friendly. In the present invention, since the catalyst is added by stages, the reaction efficiency and the stability of the synthesized product are improved.

The high-temperature resistant modified starch developed in the present invention can be applied for brine drilling fluids in a wider borehole temperature range; for example, it can be applied for formate drilling fluids, metasilicate drilling fluids, clay-free calcium chloride drilling fluids, NaCl/PHPA drilling fluids, KCl/polymeric alcohol drilling fluids, and high-performance polyamine drilling fluids, and can meet the demand for use of brine drilling fluids in deep boreholes, offshore boreholes, and boreholes in complex formations in oil exploration engineering in market and technical aspects.

In a sixth aspect of the present invention, the present invention provides a use of the above-mentioned modified starch in drilling fluids. Preferably, the modified starch is used as a filtrate reducer for drilling fluids.

In a seventh aspect of the present invention, the present invention provides a drilling fluid that contains the above-mentioned modified starch.

Since the main difference between the drilling fluid provided in the present invention and the drilling fluids in the prior art lies in the modified starch provided in the present invention, other ingredients and contents of the drilling fluid can be identical to those in conventional drilling fluids. Thus it will not be detailed further here.

Hereunder the present invention will be further detailed in some embodiments; however, the present invention is not limited to the embodiments described below. In the examples, the degree of substitution of modified starch is measured by complexometric titration as described above; the weight-average molecular weight is measured by gel permeation chromatographic analysis; the total percentage of bi-substituted starch structural units and tri-substituted starch structural units in modified starch is calculated with the following formula:

wherein:
X is the total percentage of bi-substituted starch structural units and tri-substituted starch structural unit in the modified starch;
N is the total amount of hydroxyl groups that can have substitution reaction in raw starch;
DS is the degree of substitution of the modified starch;
m is the molecular mass of the substituent group;
M is the total molecular mass of the modified starch after the substitution is completed.

### Example 1

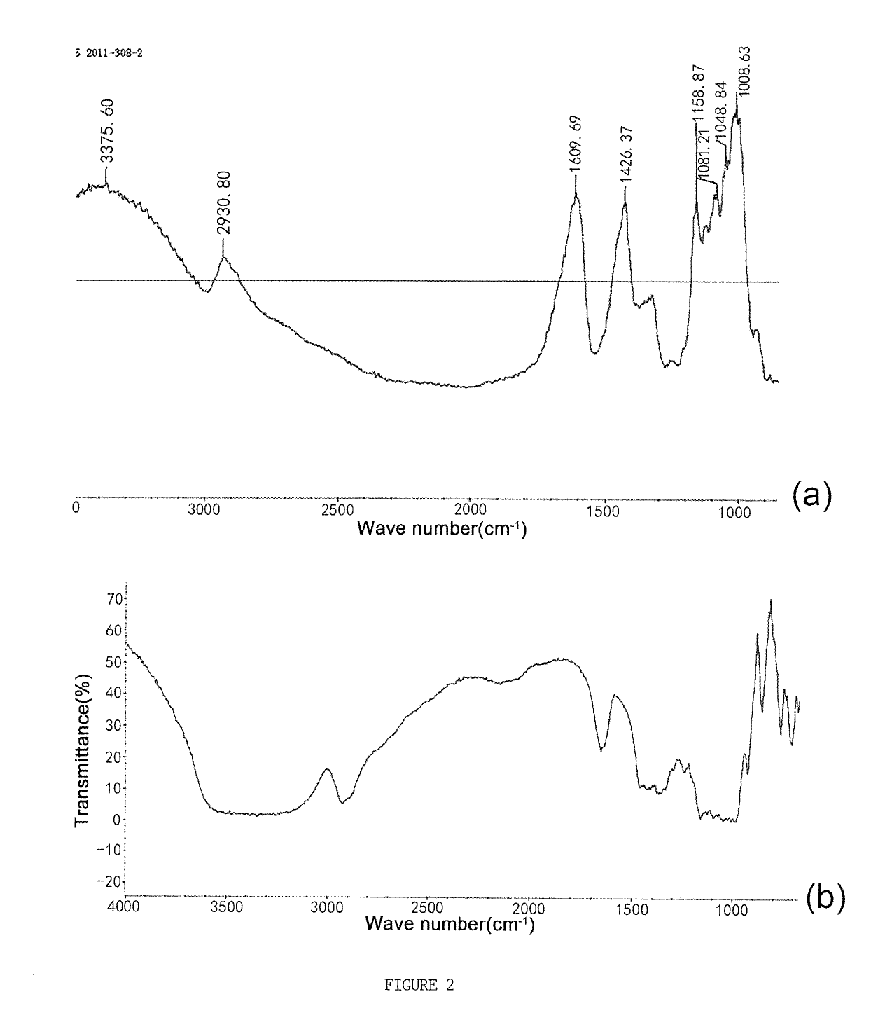

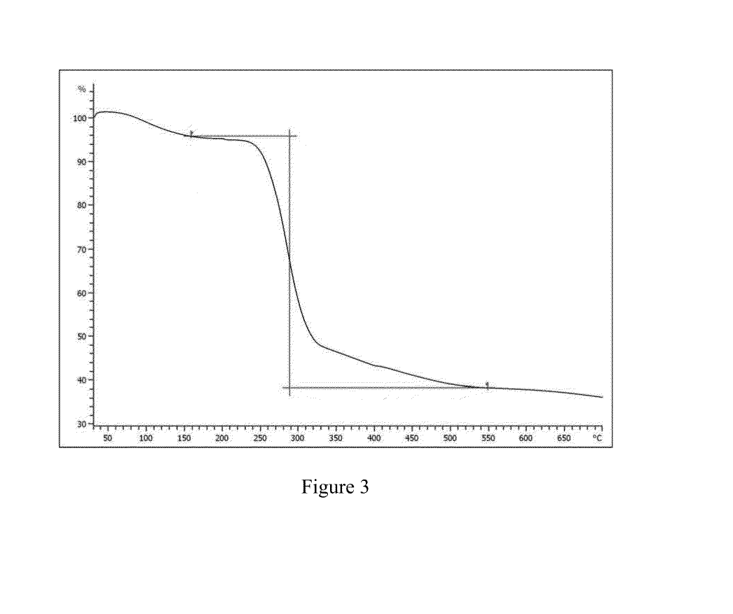

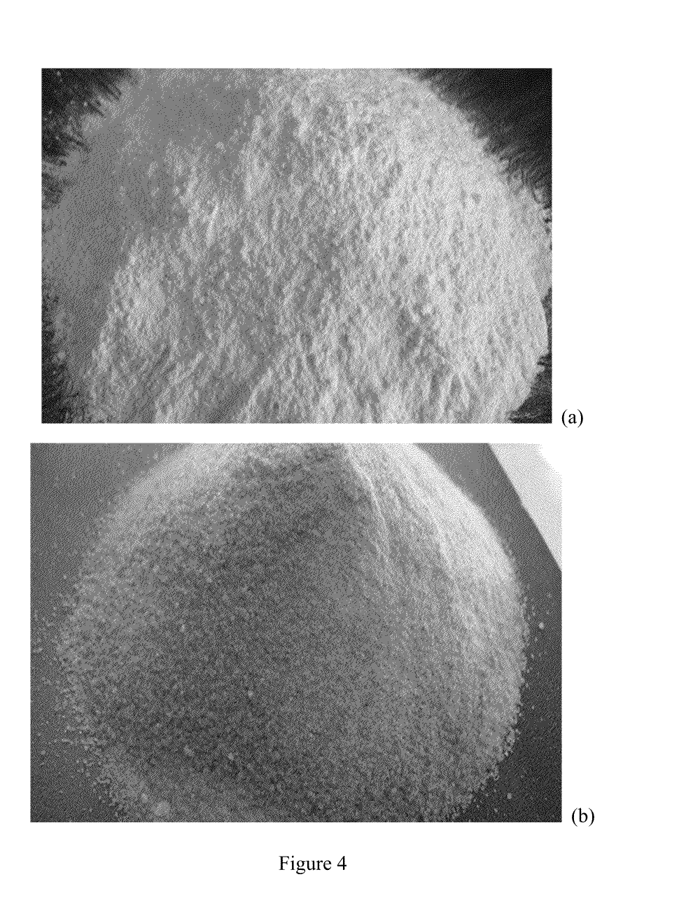

Dissolve 100 g raw maize starch (density: 1.52 g/cm³, weight-average molecular weight: 50,000-100,000) in methanol to prepare 20 wt % maize starch suspension; prepare chloroacetic acid into 5.5 wt % methanol solution of chloroacetic acid; prepare potassium hydroxide catalyst into 7 wt % potassium hydroxide solution. Load 175 g maize starch suspension into a three-neck flask, add 70 g chloroacetic acid solution and ¼ of the potassium hydroxide solution (total weight is 130 g) in sequence, control the temperature at 65° C. in thermostatic water bath and control the agitating speed at 750 rpm, and let the reaction to proceed for 3 h; then, add the remaining ¾ potassium hydroxide solution at the same temperature and same agitating speed, and let the reaction to proceed for 3 h. After the reaction, neutralize the solution to pH=7.5-9 with hydrochloric acid, and wash with methanol; then, filter the solution by suction filtration, and dry the filtrate by air blasting at 50° C. to obtain the product. A photo of the product is shown in FIG. 4(a), a SEM image of the product is shown in FIG. 1(a), the infrared spectrogram of the product is shown in FIG. 2(a), and the thermogravimetric curve of the product is shown in FIG. 3. It can be seen from FIG. 1: the particles of the modified starch are in doughnut shape, and the average ratio of inner diameter/outer diameter of doughnut is 1:10, the average thickness of doughnut is 0.2 μm, and the average particle diameter of doughnut is 3 μm. It can be seen from FIG. 2, the product exhibits an anti-symmetric stretching vibration absorption peak of CH₂ at or near wave number 2930.80 cm⁻¹, exhibits stretching vibration absorption peaks of ether bond C—O—C at or near wave numbers 1158.87 cm⁻¹, 1081.21 cm⁻¹, and 1048.84 cm⁻¹, exhibits anti-symmetric and symmetric stretching vibration absorption peaks of ion —COO— at or near wave numbers 1609.69 cm⁻¹ and 1426.37 cm⁻¹ on the infrared spectrogram, and the anti-symmetric and symmetrical stretching vibration absorption peaks that appear at or near wave numbers 1609.69 cm⁻¹ and 1426.37 cm⁻¹ have peak area equal to 4137.618 and 1651.579 respectively and have peak height equal to 18.643 and 21.460 respectively; the peak area ratio of the peaks that appear at or near wave numbers 1609.69 cm⁻¹, 1426.37 cm⁻¹, and 1158.87 cm⁻¹ is 10:3:1, and the peak height ratio of the peaks is 1:1:1. It can be seen clearly from FIG. 3: the thermal degradation of the modified starch product prepared in the present invention in nitrogen is a three-step degradation process; viewed from the inflection points on the curve, the first slight weight loss step happens between 80° C. and 100° C., mainly incurred by emission of free water in the modified starch; the second severe weight loss step happens at 250° C., mainly incurred by structure-destroying quick thermolysis of the modified starch particles in a short time; in contrast, the structure-destroying thermolysis temperature of raw starch is 100-120° C.), and the structure-destroying thermolysis temperature of the modified starch in the prior art is approx. 230° C., which proves the modified starch provided in the present invention has superior high-temperature resistance performance; the third slight weight loss step happens at 320° C., where the curve is flat and smooth, indicating the high-temperature resistance feature of the modified starch becomes steady gradually.

In addition, the degree of substitution of the product is measured as 0.45, the total content of bi-substituted starch structural units and tri-substituted starch structural units accounts for 30 wt % of the modified starch, the weight-average molecular weight of the modified starch is 520,000, and the density of the modified starch is 1.58 g/cm³.

### Example 2

Dissolve 90 g raw maize starch (density: 1.52 g/cm³, weight-average molecular weight: 50,000-100,000) in ethanol to prepare 18 wt % maize starch suspension liquid; prepare chloroacetic acid into 5 wt % chloroacetic acid solution; prepare potassium hydroxide catalyst into 9 wt % potassium hydroxide solution. Load 160 g maize starch suspension into a three-neck flask, add 60 g chloroacetic acid solution and ⅛ of the potassium hydroxide solution (total weight is 110 g) in sequence, control the temperature at 50° C. in thermostatic water bath and control the agitating speed at 900 rpm, and let the reaction to proceed for 4 h; then, add the remaining ⅞ potassium hydroxide solution at the same temperature and same agitating speed, and let the reaction to proceed for 4 h. After the reaction, neutralize the solution to pH=7.5-9 with sulfuric acid, and wash with ethanol; then, filter the solution by suction filtration, and dry the filtrate by air blasting at 55° C. to obtain the product. The infrared spectrogram, appearance in photo, and thermogravimetric curve of the product are similar to those of the product in embodiment 1, and the SEM image shows the particles of the modified starch are in doughnut, the average ratio of inner diameter/outer diameter of doughnut is 1:12, the average thickness of doughnut is 0.6 μm, and the average particle diameter of doughnut is 7 μm. In addition, the degree of substitution of the product is 0.4, the total content of bi-substituted starch structural units and tri-substituted starch structural units accounts for 25 wt % of the modified starch, the weight-average molecular weight of the modified starch is 400,000, and the density of the modified starch is 1.57 g/cm³.

### Example 3

Dissolve 110 g raw maize starch (density: 1.52 g/cm³, weight-average molecular weight: 50,000-100,000) in isopropanol to prepare 22 wt % maize starch suspension; prepare chloroacetic acid into 6 wt % chloroacetic acid solution; prepare potassium hydroxide catalyst into 8 wt % potassium hydroxide solution. Load 190 g maize starch suspension into a three-neck flask, add 80 g chloroacetic acid solution and ⅜ of the potassium hydroxide solution (total weight is 120 g) in sequence, control the temperature at 50° C. in thermostatic water bath and control the agitating speed at 600 rpm, and let the reaction to proceed for 5 h; then, add the remaining ⅝ potassium hydroxide solution at the same temperature and same agitating speed, and let the reaction to proceed for 3 h. After the reaction, neutralize the solution to pH=7.5-9 with acetic acid, and wash with isopropanol; then, filter the solution by suction filtration, and dry the filtrate by air blasting at 60° C. to obtain the product. The infrared spectrogram, appearance in photo, and thermogravimetric curve of the product are similar to those of the product in embodiment 1, and the SEM image shows the particles of the modified starch are in doughnut, the average ratio of inner diameter/outer diameter of doughnut is 1:13, the average thickness of doughnut is 1.1 μm, and the average particle diameter of doughnut is 11 μm. In addition, the degree of substitution of the product is 0.3, the total content of bi-substituted starch structural units and tri-substituted starch structural units accounts for 20 wt % of the modified starch, the weight-average molecular weight of the modified starch is 250,000, and the density of the modified starch is 1.54 g/cm³.

### Example 4

Dissolve 100 g raw maize starch (density: 1.52 g/cm³, weight-average molecular weight: 50,000-100,000) in methanol to prepare 20 wt % maize starch suspension; prepare chloroacetic acid into 5.5 wt % methanol solution of chloroacetic acid; prepare sodium hydroxide catalyst into 8 wt % sodium hydroxide solution. Load 175 g maize starch suspension into a three-neck flask, add 70 g chloroacetic acid solution and ¼ of the sodium hydroxide solution (total weight is 130 g) in sequence, control the temperature at 65° C. in thermostatic water bath and control the agitating speed at 850 rpm, and let the reaction to proceed for 4 h; then, add the remaining ¾ sodium hydroxide solution at the same temperature and same agitating speed, and let the reaction to proceed for 4 h. After the reaction, neutralize the solution to pH=7.5-9 with hydrochloric acid, and wash with methanol; then, filter the solution by suction filtration, and dry the filtrate by air blasting at 50° C. to obtain the product. The infrared spectrogram, appearance in photo, and thermogravimetric curve of the product are similar to those of the product in example 1, and the SEM image shows the particles of the modified starch are in doughnut, the average ratio of inner diameter/outer diameter of doughnut is 1:14, the average thickness of doughnut is 1.6 μm, and the average particle diameter of doughnut is 15 μm. In addition, the degree of substitution of the product is 0.35, the total content of bi-substituted starch structural units and tri-substituted starch structural units accounts for 22 wt % of the modified starch, the weight-average molecular weight of the modified starch is 300,000, and the density of the modified starch is 1.55 g/cm³.

### Example 5

Dissolve 90 g raw maize starch (density: 1.52 g/cm³, weight-average molecular weight: 50,000-100,000) in ethanol to prepare 18 wt % maize starch suspension; prepare chloroacetic acid into 5 wt % chloroacetic acid solution; prepare sodium hydroxide catalyst into 10 wt % sodium hydroxide solution. Load 160 g maize starch suspension into a three-neck flask, add 60 g chloroacetic acid solution and ⅛ of the sodium hydroxide solution (total weight is 110 g) in sequence, control the temperature at 50° C. in thermostatic water bath and control the agitating speed at 900 rpm, and let the reaction to proceed for 4.5 h; then, add the remaining ⅞ sodium hydroxide solution at the same temperature and same agitating speed, and let the reaction to proceed for 3.5 h. After the reaction, neutralize the solution to pH=7.5-9 with sulfuric acid, and wash with ethanol; then, filter the solution by suction filtration, and dry the filtrate by air blasting at 55° C. to obtain the product. The infrared spectrogram, appearance in photo, and thermogravimetric curve of the product are similar to those of the product in embodiment 1, and the SEM image shows the particles of the modified starch are in doughnut, the average ratio of inner diameter/outer diameter of doughnut is 1:15, the average thickness of doughnut is 2 μm, and the average particle diameter of doughnut is 19 μm. In addition, the degree of substitution of the product is 0.41, the total content of bi-substituted starch structural units and tri-substituted starch structural units accounts for 30 wt % of the modified starch, the weight-average molecular weight of the modified starch is 510,000, and the density of the modified starch is 1.57 g/cm³.

### Example 6

Dissolve 110 g raw maize starch (density: 1.52 g/cm³, weight-average molecular weight: 50,000-100,000) in isopropanol to prepare 22 wt % maize starch suspension; prepare chloroacetic acid into 6 wt % chloroacetic acid solution; prepare sodium hydroxide catalyst into 9 wt % sodium hydroxide solution. Load 190 g maize starch suspension into a three-neck flask, add 80 g chloroacetic acid solution and ⅜ of the sodium hydroxide solution (total weight is 120 g) in sequence, control the temperature at 50° C. in thermostatic water bath and control the agitating speed at 600 rpm, and let the reaction to proceed for 5.5 h; then, add the remaining ⅝ sodium hydroxide solution at the same temperature and same agitating speed, and let the reaction to proceed for 4 h. After the reaction, neutralize the solution to pH=7.5-9 with acetic acid, and wash with isopropanol; then, filter the solution by suction filtration, and dry the filtrate by air blasting at 60° C. to obtain the product. The infrared spectrogram, appearance in photo, and thermogravimetric curve of the product are similar to those of the product in embodiment 1, and the SEM image shows the particles of the modified starch are in doughnut, the average ratio of inner diameter/outer diameter of doughnut is 1:11, the average thickness of doughnut is 2 μm, and the average particle diameter of doughnut is 20 μm. In addition, the degree of substitution of the product is 0.36, the total content of bi-substituted starch structural units and tri-substituted starch structural units accounts for 25 wt % of the modified starch, the weight-average molecular weight of the modified starch is 500,000, and the density of the modified starch is 1.57 g/cm³.

### Example 7

Modify the raw maize starch with the method described in example 1, but use 1/9 of the total amount of catalyst in the first time. The degree of substitution of the obtained product is 0.26, the total content of bi-substituted starch structural units and tri-substituted starch structural units accounts for 15 wt % of the modified starch, the weight-average molecular weight of the modified starch is 400,000, and the density of the modified starch is 1.57 g/cm³.

### Comparison Example 1

In this Comparison Example, the modified starch is prepared with the same method that is used in Examples 1-6 (i.e., a wet process), but the catalyst is added once instead of in twice after starch and chloroacetic acid are added. The operations in the comparison example are as follows: Dissolve 110 g raw maize starch (density: 1.52 g/cm³, weight-average molecular weight: 50,000-100,000) in isopropanol to prepare 22 wt % maize starch suspension; prepare chloroacetic acid into 6 wt % chloroacetic acid solution; prepare potassium hydroxide catalyst into 8 wt % potassium hydroxide solution. Load 190 g maize starch suspension into a three-neck flask, add 80 g chloroacetic acid solution and 120 g potassium hydroxide solution (catalyst) in sequence, control the temperature at 50° C. in thermostatic water bath and control the agitating speed at 600 rpm, and let the reaction to proceed for 8 h. After the reaction, neutralize the solution to pH=7.5-9 with acetic acid, and wash with isopropanol; then, filter the solution by suction filtration, and dry the filtrate by air blasting at 60° C. to obtain the product. The infrared spectrogram of the product is similar to that shown in FIG. 4(b), and a SEM image of the product is shown in FIG. 1(b), which shows that the participles of the modified starch are not in doughnut shape. In addition, the degree of substitution of the product is 0.19, the total content of bi-substituted starch structural units and tri-substituted starch structural units accounts for 5 wt % of the modified starch, the weight-average molecular weight of the modified starch is 100,000, and the density of the modified starch is 1.53 g/cm³.

### Test Examples 1-7

Evaluate the filter loss of the modified starch products prepared in examples 1-7 as per the API standard for modified starch, i.e., Spec 13A ISO 13500 2009, wherein, the result of evaluation by 16 h aging at 140° C. is shown in Table 1, the result of evaluation by 16 h aging at 135° C. is shown in Table 2, and the result of evaluation by 16 h aging at 130° C. is shown in Table 3. In Tables 1-3, the “4% brine slurry” refers to 350 mL 4% brine+1 g NaHCO₃+35 g evaluating soil; whereas, the “saturated brine slurry” refers to 350 mL saturated brine+1 g NaHCO₃+35 g evaluating soil. In addition, unless otherwise indicated in this document, the concentration of a chemical substance always refers to the mass concentration of the chemical substance.

### Comparison Test Example 1

Evaluate the filter loss with brine slurry only, without any modified starch product, wherein, the result of evaluation by 16 h aging at 140° C. is shown in Table 1.

### Comparison Test Example 2

Evaluate the filter loss of the mixture of an imported modified starch product purchased in the market and brine slurry as per the API standard for modified starch, i.e., Spec 13A ISO 13500 2009. The reference modified starch product is prepared from cassava starch with a complex and advanced machine through a semi-dry/semi-wet process. Wherein, the result of evaluation by 16 h aging at 140° C. is shown in Table 1.

### Comparison Test Example 3

Evaluate the filter loss of the mixture of a home-made modified starch product (a SEM image of the product is shown in FIG. 3, a photo of the product is shown in FIG. 4) purchased in the market and brine slurry as per the API standard for modified starch, i.e., Spec 13A ISO 13500 2009. The reference modified starch product is prepared from maize starch through a semi-dry and semi-wet process with a machine that is simpler than the machine used to prepare the imported modified starch product. Wherein, the result of evaluation by 16 h aging at 140° C. is shown in Table 1.

### Comparison Test Example 4

Evaluate the filter loss of the modified starch product prepared in Comparison Example 1 as per the API standard for modified starch, i.e., Spec 13A ISO 13500 2009, wherein, the result of evaluation by 16 h aging at 140° C. is shown in Table 1, the result of evaluation by 16 h aging at 135° C. is shown in Table 2, and the result of evaluation by 16 h aging at 130° C. is shown in Table 3.

TABLE 1

| | | Apparent | Plastic | Dynamic | |
|---|---|---|---|---|---|
| | | viscosity | viscosity | shearing | Filter loss, ml |
| (140° C.) | Recipe | (mPa · s) | (mPa · s) | force, Pa | V_{(30 min-7.5 min)×2} |
| Test | 4% brine slurry + 1% | 6 | 4.5 | 2.5 | 8.8 |
| Example 1 | modified starch | | | | |
| | Saturated brine slurry + | 10.8 | 7.5 | 3.3 | 6.4 |
| | 1% modified starch | | | | |
| Test | 4% brine slurry + 1% | 5 | 3.5 | 1.5 | 9 |
| Example 2 | modified starch | | | | |
| | Saturated brine slurry + | 9 | 6 | 3 | 7.6 |
| | 1% modified starch | | | | |
| Test | 4% brine slurry + 1% | 5.5 | 3.5 | 2 | 8 |
| Example 3 | modified starch | | | | |
| | Saturated brine slurry + | 7.5 | 5.5 | 2 | 7 |
| | 1% modified starch | | | | |
| Test | 4% brine slurry + 1% | 5 | 3 | 2 | 8.4 |
| Example 4 | modified starch | | | | |
| | Saturated brine slurry + | 6 | 3 | 3 | 9.2 |
| | 1% modified starch | | | | |
| Test | 4% brine slurry + 1% | 5.5 | 3 | 2.5 | 8.8 |
| Example 5 | modified starch | | | | |
| | Saturated brine slurry + | 6 | 4 | 2 | 7.4 |
| | 1% modified starch | | | | |
| Test | 4% brine slurry + 1% | 8 | 4 | 4 | 9.6 |
| Example 6 | modified starch | | | | |
| | Saturated brine slurry + | 8 | 5 | 3 | 8.4 |
| | 1% modified starch | | | | |
| Test | 4% brine slurry + 1% | 8 | 4 | 4 | 9.8 |
| Example 7 | modified starch | | | | |
| | Saturated brine slurry + | 8 | 5 | 3 | 9.4 |
| | 1% modified starch | | | | |
| Comparison | 4% brine slurry | 5.5 | 3.5 | 2 | Lost fully |
| Test | Saturated brine slurry | 7.5 | 5.5 | 2 | Lost fully |
| Example 1 | | | | | |
| Comparison | 4% brine slurry + 1% | 5.5 | 5 | 0.5 | 10.4 |
| Test | modified starch | | | | |
| Example 2 | Saturated brine slurry + | 14 | 11 | 3 | 11 |
| | 1% modified starch | | | | |
| Comparison | 4% brine slurry + 1% | 5 | 3 | 2 | 10.6 |
| Test | modified starch | | | | |
| Example 3 | Saturated brine slurry + | 4.8 | 4.5 | 0.3 | 12 |
| | 1% modified starch | | | | |
| Comparison | 4% brine slurry + 1% | 7.5 | 4 | 3.5 | 110 |
| Test | modified starch | | | | |
| Example 4 | Saturated brine slurry + | 4.5 | 3.5 | 1 | 140 |
| | 1% modified starch | | | | |

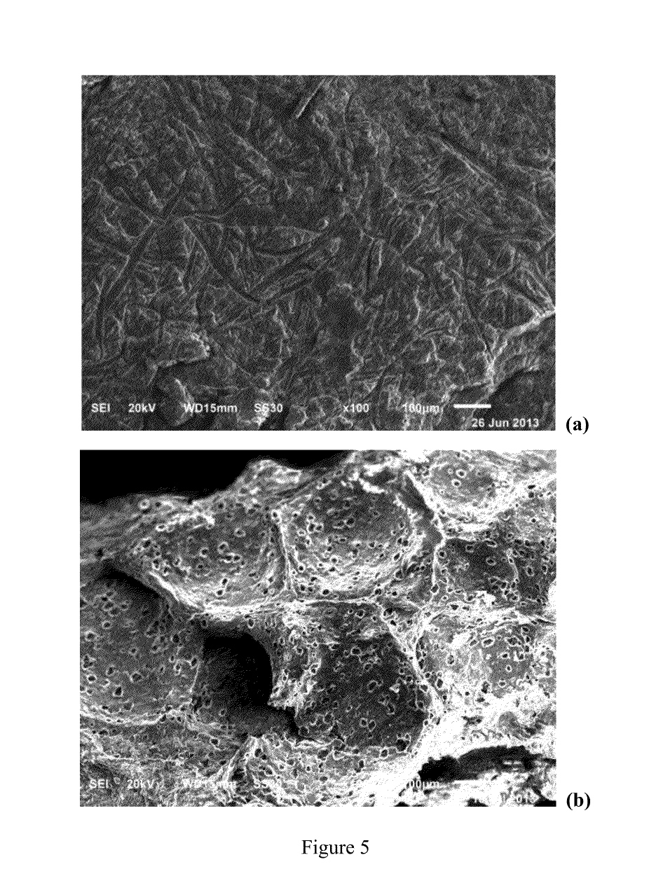

The SEM images of the mud cakes obtained in above tests are shown in FIG. 5, wherein, FIG. 5(a) is the SEM image of the mud cake obtained in test case 1, and FIG. 5(b) is the SEM image of the mud cake obtained in test case 3. It can be seen from FIG. 5: the mud cake that is obtained with the modified starch provided in the present invention as the filtrate reducer is very dense; whereas, the mud cake obtained with a commercial etherified starch product as the filtrate reducer has a large quantity of pores and poor filtrate reduction performance.

TABLE 2

| | | Apparent | Plastic | Dynamic | |
|---|---|---|---|---|---|
| | | viscosity | viscosity | shearing | Filter loss, ml |
| (135° C.) | Recipe | (mPa · s) | (mPa · s) | force, Pa | V_{(30 min-7.5 min)×2} |
| Test | 4% brine slurry + 1% | 8 | 7 | 3.5 | 8 |
| Example 3 | modified starch | | | | |
| | Saturated brine slurry + | 14 | 10 | 3 | 7 |
| | 1% modified starch | | | | |
| Comparison | 4% brine slurry | 6 | 3.5 | 2 | Lost fully |
| Test | Saturated brine slurry | 7.5 | 5.5 | 2 | Lost fully |
| Example 1 | | | | | |
| Comparison | 4% brine slurry + 1% | 4.5 | 3 | 1.5 | 56 |
| Test | modified starch | | | | |
| Example 4 | Saturated brine slurry + | 5 | 5 | 0 | 90 |
| | 1% modified starch | | | | |

TABLE 3

| | | Apparent | Plastic | Dynamic | |
|---|---|---|---|---|---|
| | | viscosity | viscosity | shearing | Filter loss, ml |
| (130° C.) | Recipe | (mPa · s) | (mPa · s) | force, Pa | V_{(30 min-7.5 min)×2} |
| Test | 4% brine slurry + 1% | 10.5 | 6 | 4.5 | 7 |
| Example 3 | modified starch | | | | |
| | Saturated brine slurry + | 14 | 10 | 4 | 6 |
| | 1% modified starch | | | | |
| Comparison | 4% brine slurry | 6 | 4 | 2 | Lost fully |
| Test | Saturated brine slurry | 7.5 | 5.5 | 2 | Lost fully |
| Example 1 | | | | | |
| Comparison | 4% brine slurry + 1% | 6 | 4 | 2 | 25 |
| Test | modified starch | | | | |
| Example 4 | Saturated brine slurry + | 4.5 | 4 | 0.5 | 50 |
| | 1% modified starch | | | | |

As evaluated by 16 h aging at 140° C. as per the API standard for modified starch (Spec 13A ISO 13500 2009), the product prepared with the method disclosed in the present invention has much higher filtrate reduction performance after 16 h aging at 140° C. in 4% brine slurry or saturated brine slurry, when compared to existing home-made or imported commercial products and the product prepared with the preparation method in the prior art; especially, when used in saturated brine slurry, the product prepared with the method disclosed in the present invention is much superior to similar home-made or imported products. It can be seen from Table 1: when evaluated by 16 h aging at 140° C. in saturated brine slurry, the modified starch product prepared in Example 1 has the best performance; whereas, when evaluated by 16 h aging at 140° C. in 4% brine slurry, the modified starch product prepared in Example 3 has the best performance. In addition, it can be seen from Table 2 and Table 3: the modified starch product prepared with the method disclosed in the present invention also have stable performance when tested at 135° C. and 130° C.

The percentages of modified starch added into the samples tested in the evaluations shown in Tables 1-3 are 1 wt %; actually, the higher the percentage of modified starch in the sample is, the higher the filtrate reduction performance will be, and the higher the temperature resistance will be; though only 1 wt % modified starch is added in the embodiments of the present invention, it is apparent that the obtained products have significant advantage over the product obtained in the reference embodiment; on the other hand, it means that the product obtained in the present invention can be used at a small dosage in actual industrial applications and therefore has high economic efficiency. Moreover, it can be seen from the filter loss of the product in Example 1 as shown in Tables 1-3, as the temperature increases, the increased amount of water loss in the modified starch prepared with the method provided in the present invention is very low, which is to say, the modified starch prepared with the method provided in the present invention has favorable temperature resistance performance.

In the present invention, FIG. 4(a) shows a photo of the modified starch product prepared with the method in Example 1 of the present invention, and FIG. 4(b) shows a photo of the modified starch product used in Comparison Test Example 3. It is seen from the figures: both the granularity and the color of the product prepared with the method provided in the present invention are superior to those of the reference samples of home-made and imported products (the two reference products are in white and husk yellow respectively). The product provided in the present invention is finer, and is in a color that is close to the color of commercial raw maize starch.

1. A modified starch comprising bi-substituted starch structural units and tri-substituted starch structural units, wherein, the tri-substituted starch structural units are represented by the following formula (1), the bi-substituted starch structural units are the structural units represented by the following formula (2) and/or the structural units represented by the following formula (3), and the total content of the bi-substituted starch structural units and tri-substituted starch structural units accounts for 20 wt % or more of the modified starch, the weight-average molecular weight of the modified starch is 50,000-600,000, 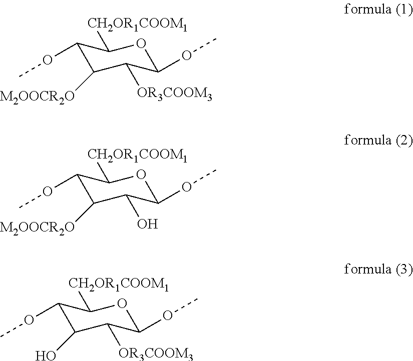
wherein, R₁, R₂, and R₃ are independently selected from C1-C5 alkylene respectively, and M₁, M₂, and M₃ are independently selected from H, alkali metal element, or alkaline earth metal element respectively.

2. The modified starch according to claim 1, wherein R₁, R₂, and R₃ are methylene respectively, and M₁, M₂, and M₃ are H or Na respectively.

3. The modified starch according to claim 1, wherein the degree of substitution of the modified starch is 0.2-0.5.

4. The modified starch according to claim 1, wherein the particles of the modified starch are doughnut shape, and the average ratio of inner diameter to outer diameter of doughnut is 1:10-1:15, the average thickness of doughnut is 0.1-2 μm, and the average particle diameter of doughnut is 3-20 μm.

5. The modified starch according to claim 4, wherein 1-2 doughnuts are connected into ∝ shape or ∞ shape.

6. The modified starch according to claim 1, wherein the density of the modified starch is 1.2-1.8 g/cm³.

7. The modified starch according to claim 1, wherein the filter loss of the modified starch is less than 10 ml when it is used in industrial applications without any deoxidant and bactericide, as evaluated by 16 h aging test at 140° C. as per the API standard for modified starch, i.e., Spec 13A ISO 13500 2009.

8. The modified starch according to claim 1, which exhibits an anti-symmetric stretching vibration absorption peak of —CH₂ at or near wave number 2930.80 cm⁻¹, exhibits stretching vibration absorption peaks of ether bond C—O—C at or near wave numbers 1158.87 cm⁻¹, 1081.21 cm⁻¹, and 1048.84 cm⁻¹, and exhibits anti-symmetric and symmetric stretching vibration absorption peaks of ion —COO— at or near wave numbers 1609.69 cm⁻¹ and 1426.37 cm⁻¹ on the infrared spectrogram.

9. The modified starch according to claim 8, wherein the peak height ratio of anti-symmetric stretching vibration absorption peak of ion —COO— that appears at or near wave number 1609.69 cm⁻¹: symmetric stretching vibration absorption peak of ion —COO— that appears at or near wave number 1426.37 cm⁻¹: stretching vibration absorption peak of ether bond C—O—C that appears at or near wave number 1158.87 cm⁻¹ is 1-2:1-2:1, and the peak area ratio of the three peaks is 10-13:3-6:1.

10. The modified starch according to claim 8, wherein the filter loss of the modified starch is less than 10 ml when it is used in industrial applications without any deoxidant and bactericide, as evaluated by 16 h aging test at 140° C. as per the API standard for modified starch, i.e., Spec 13A ISO 13500 2009.

11. A method for preparation of modified starch, comprising: controlling a mixture that contains raw starch, starch acylating agent, and solvent to contact with a basic catalyst, wherein, the contact between the mixture contains raw starch, starch acylating agent, and solvent and the basic catalyst comprises at least two stages, the contact time in the first stage is 1-48 h, and the amount of the basic catalyst used in the first stage accounts for 1/16-½ of the total amount of the basic catalyst.

12. The preparation method according to claim 11, wherein the contact time in the first stage is 3-6 h, and the amount of basic catalyst used in the first stage accounts for ⅛-⅜ of the total amount of the basic catalyst.

13. The preparation method according to claim 11, wherein the weight ratio of raw starch:starch acylating agent:solvent:basic catalyst is 1:0.06-0.2:4-7:0.17-0.33.

14. The preparation method according to claim 11, wherein the contact happens in two stages, and the contact time in the second stage is 0.5-24 h.

15. The preparation method according to claim 11, wherein the contact temperatures in each stage may be the same as or different from each other, and are 40-70° C. respectively.

16. The preparation method according to claim 11, wherein the starch acylating agent is C2-C4 halogenated carboxylic acid, and the mixture that contains raw starch, starch acylating agent, and solvent is prepared by mixing raw starch with water to form a suspension and then mixing the suspension with solution of the starch acylating agent and/or low carbon alcohol solution of the starch acylating agent, the concentration of the suspension is 15-25 wt %, the concentration of the water solution of starch acylating agent is 3-10 wt %.

17. The preparation method according to claim 11, further comprising: neutralizing the mixture obtained through contact reaction with acid to pH=7.5-9, and then washing the mixture with low carbon alcohol and drying the mixture.

18. The preparation method according to claim 11, comprising: dissolving raw starch in low carbon alcohol to obtain a 15-25 wt % starch suspension; firstly adding 1-2 part by weight (pbw) 3-10 wt % chloroacetic acid solution into 3-4 pbw starch suspension, and then adding 2-3 pbw 4-11 wt % basic catalyst solution into the starch suspension in twice, wherein the weight of basic catalyst solution added in the first time accounts for ⅛-⅜ of the total weight of the basic catalyst solution, the mixture is kept at 40-70° C. to react for 1-48 h after the basic catalyst solution is added for the first time, and then the remaining basic catalyst solution is added and the mixture is kept at 40-70° C. to react further for 0.5-24 h; neutralizing the solution with acid to pH=7.5-9 after the reaction; washing the product of the reaction with low carbon alcohol and then drying the product of the reaction to obtain the final product.

19. The preparation method according to claim 11, wherein the raw starch is one or more selected from the group of raw maize starch, raw potato starch, and raw cassava starch; the low carbon alcohol is one or more of methanol, ethanol, and isopropanol; the basic catalyst is sodium hydroxide and/or potassium hydroxide, and the basic catalyst solution is water solution or alcoholic solution of the basic catalyst.

20. A drilling fluid that contains the modified starch set forth in claim 1.
